(19) United States
(12) Patent Application Publication
(10) Pub. No.: US 2009/0167767 A1
(43) Pub. Date: Jul. 2, 2009

(54) GROWING AND CARING FOR A VIRTUAL CHARACTER ON A MOBILE DEVICE

(76) Inventor: Dror SHOVAL, Fremont, CA (US)

Correspondence Address: Fleit Gibbons Gutman Bongini & Bianco PL, 21355 EAST DIXIE HIGHWAY, SUITE 115, MIAMI, FL, 33180, US

(21) Appl. No.: 11/967,292

(22) Filed: Dec. 31, 2007

(51) Int. Cl. G06T 13/00

(52) U.S. Cl. 345/473; 345/418

(57) ABSTRACT

A computer implemented method, data processing system, and computer program product for enabling a user to create and care for a virtual character on a user communication device. The data processing system includes a server connected via a communication network to a user communication device. In response to a user action, a software application with a virtual character in it is downloaded into the user communication device. The virtual character interacts with the user through the software application in accordance with predefined characteristics. The user is enabled to perform virtual actions relating to the virtual character, responsive to the virtual character behavior, by sending data (e.g., by SMS or MMS) using the user communication device over the communication network to the server. The virtual character is responsive to data sent to it from the server in response to the user's virtual actions, in accordance with the virtual character's predefined characteristics.

### TECHNICAL FIELD

The present invention relates to multimedia systems and, more particularly, to virtual user interaction in such systems.

### BACKGROUND OF THE INVENTION

In recent years, more and more people are experiencing the world through virtual embodiments thereof. Data mining, online shopping, online dating, social networks, all became very popular and people spend substantial amount of time using and interacting with these environments.

The success of any virtual environment depends usually on the ability of the creator of the virtual environment to imitate the defining properties (virtues) of the real environments and implement them effectively in the digital medium.

Mobile phones and other personal device accessories (PDA) with multimedia capabilities and wireless communication connectivity have also become very popular in recent years. People tend to use these devices as an interface to online environment and virtual applications.

Growing a pet in the real world is resource and time consuming and requires an adequate level of responsibility. It would be advantageous if a virtual environment that imitates the defining properties of growing a pet existed. Such environment could serve as a substitute to pet growing, or alternatively as a pilot preceding the acquiring of such a pet.

### SUMMARY OF THE INVENTION

Embodiments of the present invention suggest using mobile phones and PDAs with wireless connectivity as a platform for a virtual environment in which a virtual character is created, grown and cared for by the user. User interaction related to the care of the virtual character in enabled through short message service (SMS) or multimedia service (MMS).

In embodiments, tracking the user interaction is enabled for a third party willing to monitor such interaction. Thus, parents willing to check their children readiness for a pet may monitor their children interaction with a virtual pet.

In other embodiments, multiple users may interact simultaneously with the same virtual character. Thus enabling the users to experience cooperation.

### BRIEF DESCRIPTION OF THE DRAWINGS

The subject matter regarded as the invention will become more clearly understood in light of the ensuing description of the embodiments herein, given by way of example and for purposes of illustrative discussion of the present invention only, with reference to the accompanying drawings (Figures, or simply “FIGS.”), wherein:

FIG. 1 is a schematic block diagram according to some embodiments of the disclosure; and

FIG. 2 is a schematic flowchart diagram showing the stages according to some embodiments of the disclosure;

The drawings together with the description make apparent to those skilled in the art how the invention may be embodied in practice.

Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the disclosure. However, it will be understood by those skilled in the art that the teachings of the present disclosure may be practiced without these specific details. In other instances, well-known methods procedures, components and circuits have not been described in detail so as not to obscure the teachings of the present disclosure.

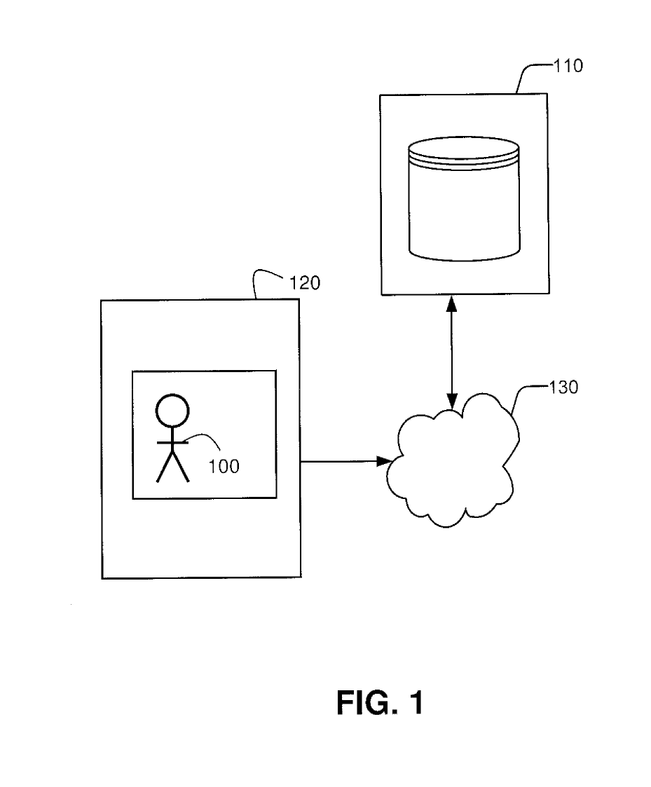

FIG. 1 is a schematic block diagram depicting a data processing system for enabling a user to create and care for a virtual character 100 on a user communication device. The data processing system includes a server 110 connected via a communication network 130 to a user communication device 120.

In response to a user action, a software application with a virtual character 100 in it is downloaded into the user communication device 120. Virtual character 100 interacts with the user through the software application in accordance with predefined characteristics.

The user is enabled to perform virtual actions relating to virtual character 100, responsive to the virtual character behavior, by sending data using the user communication device 120 over the communication network 130 to the server 110. The virtual character 100 is responsive to data sent to it from the server 110 in response to the user's virtual actions, in accordance with the virtual character's predefined characteristics.

According to some embodiments of the invention, the user communication device may be a cellular phone of any type and kind, a personal device accessory (PDA) or a portable personal computer with wireless connectivity.

According to some embodiments of the invention, the communication network may be any network that enables a handshake protocol for verifying data transfer. Such network may be a cellular telephony network that supports SMS and MMS, and any wireless Internet connection.

According to some embodiments of the invention, the user performs the virtual actions by sending one of the following: an SMS, an MMS, an Internet communication session. These actions are billable in accordance with a predefined billing scheme.

According to some embodiments of the invention, the software application comprising the virtual character is downloaded from a website on the Internet. The user is required to register and supply his or her details. Then the user is presented with the available virtual character and their corresponding characteristics.

According to some embodiments of the invention, the software application comprising the virtual character is downloaded from a hardware memory component, such as a flash memory card, attached to the user communication device. The memory card, after downloading the virtual character, may be used as a regular memory card.

According to some embodiments of the invention, the virtual character is animated. It may be presented in any multimedia format, combining both video and audio, such as MPEG 4 or the like.

According to some embodiments of the invention, the virtual character imitates a pet, such as a dog, cat, fish, bird and the like. It is then attributed with the corresponding characteristics of the specific pet it initiates.

According to some embodiments the virtual character may be a baby, an infant, a plant and anything that requires attention and treatment.

According to some embodiments of the invention the virtual character notifies the user of actions that are required in real-time, such as food, water, going for a walk, illness and the like.

According to some embodiments of the inventions wherein the user's actions are monitored by a third party. The third party may have its own user communication device through which he or she is kept updated. This embodiment may be useful for parents who whish to monitor the process of rowing and caring for a pet by their child, thus promoting responsibility.

According to some embodiments of the invention multiple users are enabled to cooperate in growing and caring for said virtual character. This embodiment enable a couple or friends to see hoe they cooperate in order to deliver a mutual mission.

According to some embodiments of the invention, the user is enabled to virtually buy accessories for the virtual character. These may resemble real life goods and are ordered by either SMS, MMS or an Internet session.

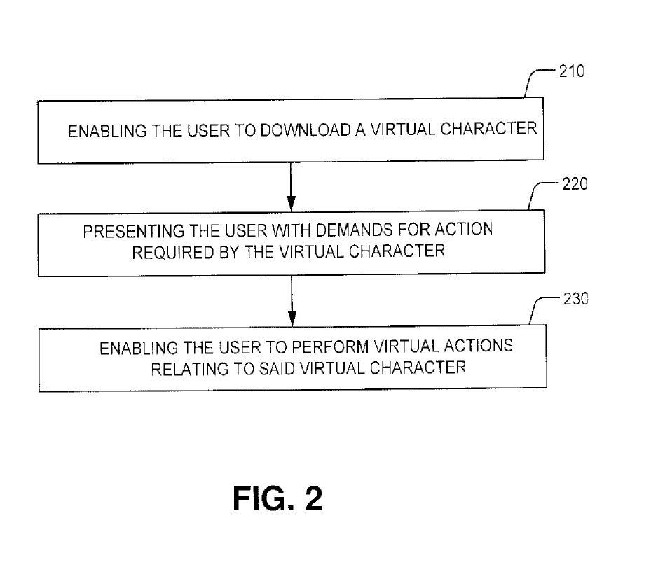

FIG. 2 is a flowchart showing the stages of the computer implemented method according to some embodiments of the invention.

The method comprise enabling the user to download a virtual character 210; presenting the user with demands for action required by the virtual character, in accordance with predefined characteristics 220; and enabling the user to perform virtual actions relating to said virtual character by sending a message to a server via said user communication device 230.

According to some embodiments of the invention, enabling the user to perform virtual actions is performed by at least one of the following ways: SMS sending, MMS sending, establishing an internet communication session.

According to some embodiments of the invention, the computer implemented method further comprises enabling the user to purchase virtual goods for the virtual character.

According to some embodiments of the invention, the computer implemented method further comprises presenting the user with advertisement related to actions required by said virtual character, wherein said advertisement relates also the user's real requirements.

According to some embodiments of the invention, the computer implemented method further comprises enabling a third party to monitor the actions of the user related to the virtual character. Thus, a parent may monitor the way his or her child take care of a virtual character such as a dog.

According to some embodiments of the invention, the computer implemented method further comprises enabling a plurality of users to cooperate and simultaneously grow and care for the virtual character.

According to some embodiments of the invention there is provided a computer program product to enable a user to create and care for a virtual character on a user communication device. The computer program product comprises: a computer usable medium having computer usable program code tangibly embodied thereon, the computer usable program code comprises: computer usable program code for enabling the user to download a virtual character, computer usable program code for presenting the user with demands for action required by the virtual character, in accordance with predefined characteristics, and computer usable program code for enabling the user to perform virtual actions relating to said virtual character by sending a message to a server via said user communication device.

According to some embodiments of the invention, the system, method, computer program product and signal can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output.

The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such its internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a cellular telephony network, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In the above description, an embodiment is all example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature structure, or characteristic described in connection with the embodiments is included in at least some embodiments, but not necessarily all embodiments, of the inventions.

It is understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

What is claimed is:

1. A data processing system for enabling a user to create and care for a virtual character on a user communication device, said data processing system comprising
a server connected via a communication network to
a plurality of user communication devices;
wherein responsive to a user action, a software application comprising a virtual character is downloaded into said user communication device;
and wherein said virtual character interacts with said user via said software application in accordance with predefined characteristics;
and wherein said user is enabled to perform virtual actions relating to said virtual character, responsive to the virtual character behavior, by sending data using the user communication device over the communication network to the server;
and wherein said virtual character is responsive to data sent to it from the server in response to the user's virtual actions, in accordance with the virtual character's predefined characterisitics.

2. The data processing system according to claim 1, wherein the user communication device is at least one of the following: a cellular phone, a personal device accessory (PDA), a portable personal computer.

3. The data processing system according to claim 1, wherein the communication network is at least one of the following: a cellular telephony network wireless Internet connection.

4. The data processing system according to claim 1, wherein the user performs the virtual actions by sending one of the following: an SMS, a MMS, an Internet communication session.

5. The data processing system according to claim 1, wherein the software application comprising the virtual character is downloaded from a website.

6. The data processing system according to claim 1, wherein the software application comprising the virtual character is downloaded from a hardware memory component attached to the user communication device.

7. The data processing system according to claim 1, wherein the virtual character is animated.

8. The data processing system according to claim 1, wherein the virtual character imitates a pet.

9. The data processing system according to claim 1, wherein the virtual character notifies the user of actions that are required in realtime.

10. The data processing system according to claim 1, wherein the user's actions are monitored by a third party.

11. The data processing system according to claim 1, wherein multiple users are enabled to cooperate in growing and caring for said virtual character.

12. The data processing system according to claim 1, wherein the user is enabled to virtually buy accessories for the virtual character.

13. A computer implemented method to enable a user to create and care for a virtual character on a user communication device, said method comprising:
enabling the user to download a virtual character;
presenting the user with demands for action required by the virtual character, in accordance with predefined characteristics;
enabling the user to perform virtual actions relating to said virtual character by sending a message to a server via said user communication device.

14. The computer implemented method of claim 13, wherein enabling the user to perform virtual actions is performed by at least one of the following ways: SMS sending, MMS sending, establishing an Internet communication session.

15. The computer implemented method of claim 13, further comprising:
enabling the user to purchase virtual goods for the virtual character.

16. The computer implemented method of claim 13, further comprising:
presenting the user with advertisement related to actions required by said virtual character, wherein said advertisement relates also the user's real requirements.

17. The computer implemented method of claim 13, further comprising:
enabling a third party to monitor the actions of the user related to the virtual character.

18. The computer implemented method of claim 13, further comprising:
enabling a plurality of users to cooperate and simultaneously grow and care for the virtual character.

19. A computer program product to enable a user to create and care for a virtual character on a user communication device, said computer program product comprising:
a computer usable medium having computer usable program code tangibly embodied thereon, the computer usable program code comprising:
computer usable program code for enabling the user to download a virtual character;
computer usable program code for presenting the user with demands for action required by the virtual character, in accordance with predefined characteristics;
computer usable program code for enabling the user to perform virtual actions relating to said virtual character by sending a message to a server via said user communication device.

20. The computer program product according to claim 19, wherein enabling the user to perform virtual actions is performed by at least one of the following ways: an SMS, a MMS, an Internet communication session.
